(19) United States
(12) Patent Application Publication
(10) Pub. No.: US 2010/0106730 A1
(43) Pub. Date: Apr. 29, 2010

(54) METHOD OF INTERMEDIATION WITHIN A SOCIAL NETWORK OF USERS OF A SERVICE/APPLICATION TO EXPOSE RELEVANT MEDIA ITEMS

(76) Inventors: Mehdi AMINIAN, Lausanne (CH); Zeno Crivelli, Lausanne (CH)

Correspondence Address: BLANK ROME LLP, WATERGATE, 600 NEW HAMPSHIRE AVENUE, N.W., WASHINGTON, DC, 20037, US

(21) Appl. No.: 12/606,579

(22) Filed: Oct. 27, 2009

Related U.S. Application Data
(63) Continuation of application No. PCT/EP2008/055393, filed on Apr. 30, 2008.

(30) Foreign Application Priority Data
Apr. 30, 2007 (EP) EP07107200.3

(51) Int. Cl. G06F 3/048; G06F 17/30

(52) U.S. Cl. 707/748; 715/716; 715/810; 707/754; 707/E17.009

(57) ABSTRACT

The present invention relates to a method where consumers, using an electronic networked terminal, play an active and crucial role in detecting, promoting, popularizing, accessing, performing financial transactions for and consuming content media items and/or their creators and/or any other linked information. In one embodiment, the invention relates to a method where a list (1) of media items identified as being of interest by one or several users (5) in a list (4) is automatically generated and presented on the device display of a particular user.

This application is a continuation of International application PCT/EP2008/055393 filed on Apr. 30, 2008, the content of which being herewith enclosed by reference. It claims priority of European patent application EP07107200, filed on Apr. 30, 2007, the content of which being herewith incorporated by reference.

### FIELD OF THE INVENTION

The present invention concerns a method to recommend media items to users. The invention also concerns a method of intermediation within a social network of users of a service/application to enable “word-of-mouth” like recommendations of media items within a community of users, based on their measured interest for media items.

### RELATED ART

Systems for presenting lists of media items are known and used for instance in the music, video or entertainment industry. Electronic shops propose lists of music songs, videos or books that users can select, view, listen to or buy. Similar lists are used for managing the users' own music or video collections, in websites proposing video on demand, and so on. Popular software for presenting, sorting and filtering lists of media items include for example Apple iTunes, Windows Media Player, YouTube or Flickr (all registered trademarks in some countries).

As the number of media systems that may be managed with such a system may be very large, some systems propose lists of recommended media items. Those lists may be established by an administrator of the system, or based on user profiles or preferences, or on the users' previous selections. Systems of automatic recommendations based on the behaviour of other anonymous users are also known. However, a particular user who receives such a recommendation does not know its origin and whether he can trust the tastes of the referrer. The quality of recommendations is therefore relatively poor, and cannot be improved by the user. As a consequence, long lists of media items are generated which contain many media items that do not interest the recipient. The transmission, display and storage of this list require a lot of computer (and human) resources.

On the other hand, social network systems, platforms for chats, blogs, forums and similar systems are widely used in the Web and allow many users to communicate and share experiences. Those various social network systems are often used by users who want to promote media items and inform their family or friends about new media items they discovered. In this case, recommendations are usually not anonymous, but they are mostly manual and require an explicit action of the referrer and/or of the recipient for the transmission of the recommendation.

### AIM OF THE INVENTION

It is the aim of the present invention to propose a method and a computer program product where consumers, using an electronic networked terminal, play a more active role to detect, promote, popularize access, perform financial transactions for, and consume content media items and/or their creators and/or any other linked information.

It is another aim of the invention to propose a method for reducing the size of lists of recommended media items, without reducing the number of interesting media items proposed to the user.

It is another aim of the invention to propose a new method for recommending media items to other users, including members of a virtual community.

### SUMMARY OF THE INVENTION

According to the invention, these aims are achieved by means of a method according to the independent claim, whereas advantageous embodiments of the invention are disclosed in the dependant claims and in the description.

These aims are in particular achieved with a method for recommending media items to a particular user, wherein a list of other users is presented on a user device display to said particular user in a dedicated view or section, and wherein a set of media items has been identified as being of interest by said other users in said list and/or for said other users in said list, personally and on an individual basis, and where a list of media items identified as being of interest by said other users in said list is automatically generated and presented on said user device display.

This method thus has the advantage of automatically generating lists of recommended items. The list is associated with the originating referrer (the other user) and each particular user can decide whether he trusts or not the tastes of this other user.

### BRIEF DESCRIPTION OF THE DRAWINGS

The invention will be better understood with the aid of the description of an embodiment given by way of example and illustrated by the figures, in which:

FIG. 1 illustrates a list of media items that may be shown on the display of one particular user. This list includes media items of interest of one or several other users, and may be used as a source of recommendation by the particular user viewing the list.

FIG. 2 illustrates a detail of the view of FIG. 1, showing in particular selectors, whereas each one of such selectors is presented with a value representing the number of unknown or new media items to the particular user.

FIG. 3 illustrates another detail of the view of FIG. 1, showing in particular a list (or group) of recommended selectors presented right below a list of preferred selectors.

FIG. 4 illustrates another detail of the view of FIG. 1, where the possibility for an user to add another user to its list of preferred user is illustrated, for example by using a graphical user interface method, for instance by clicking on a dedicated widget button.

FIG. 5 illustrates another detail of the view of FIG. 1, wherein a score or rank is associated and displayed next to one other user. The user's score is a calculated numerical value indicating for example the activity of each user.

FIG. 6 illustrates another detail of the view of FIG. 1, wherein a score or rank is associated and displayed next to one media item. The media item's score is a calculated numerical value.

FIG. 7 illustrates a widget that can be used for filtering a list of media items presented to a particular user. The filtering is based on a numerical value used as a threshold. The widget in this non limitating example is s a linear or a rotary slider. FIG. 7 also illustrates a view called “Fresh”.

FIG. 8 illustrates a possible presentation of media items in different sections, where the second section, called “Popular”, presents media items sorted in order of most popular media item first.

### DETAILED DESCRIPTION OF POSSIBLE EMBODIMENTS OF THE INVENTION

### Definitions

Media item: In this application, the expression “media item” or “item” designates any digital file or data with artistic or informative contents, including for example music, videos, photos, texts, web pages, websites, books, people, physical items and the like. In a preferred embodiment, media items are digital files or sets of files that can be loaded over the Internet and/or stored on a digital storage medium, for example music items, including for example .mp3 files, video files, and so on. The invention is especially well adapted to music where media items are songs.

Particular user: In this application, the expression “particular user” designates the individual using the service/application from his own perspective. The figures illustrate examples of the applications or web pages presented on the device's display of the particular user.

Other users: In this application, the expression “other users” means all users of the service, except the particular user. Together with the particular user they represent 100% of all the users of the service/application.

Recommended other users: In this application, the expression “recommended other users” (also called “recommended taste leaders”) means other users recommended to the particular user. The other user may be connected to the same server or set of servers as the particular user, for example over the Internet, and thus shares information and recommendations.

Preferred other users: In this application, the expression “preferred other users” (also called “preferred taste leaders”, or “my taste leaders” if they are those of the particular user) means all the other users that the particular user has chosen manually as his preferred other users (for instance from the list of his recommended other users).

In one aspect, the invention relates to a method for recommending media items to a particular user by using lists of media items of interest of one or several other users as the source of media items recommendations to the particular user. This method implements an electronic and automatic word-of-mouth system between users for discovering relevant and entertaining new media items.

The method uses a central server or a set of servers (not shown) to which all users can connect over a network such as the Internet. The central server or servers comprises a database for storing user preferences, recommendations, lists of preferred users, lists of media items bought or otherwise consumed, etc. The users may use various devices to access this server, including but no restricted to personal computers, personal digital assistants (PDAs), cell phones, personal music players, etc. However, the invention is not restricted to a centralized system with a central server but may also be used within a peer-to-peer system for example.

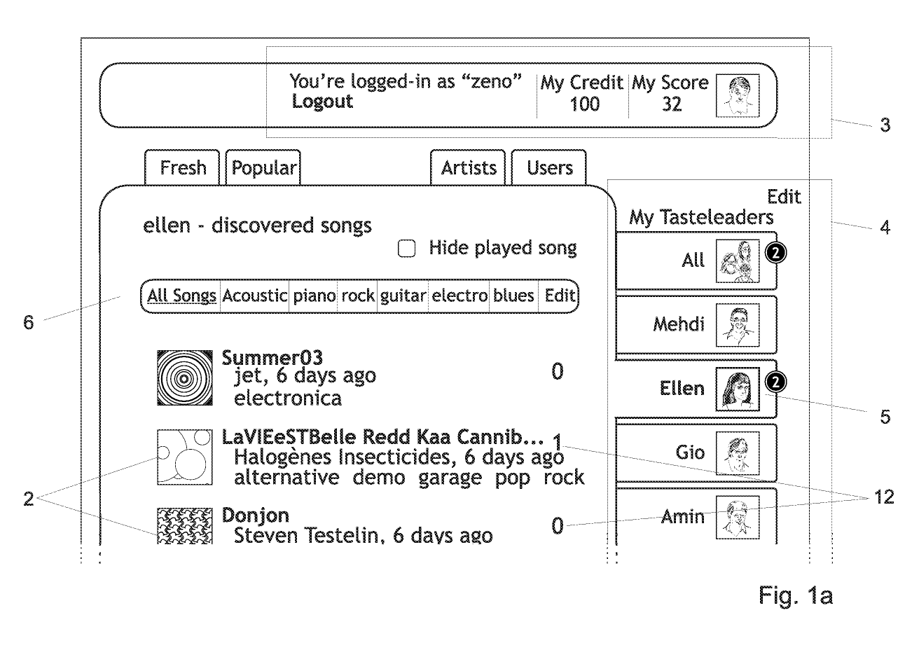

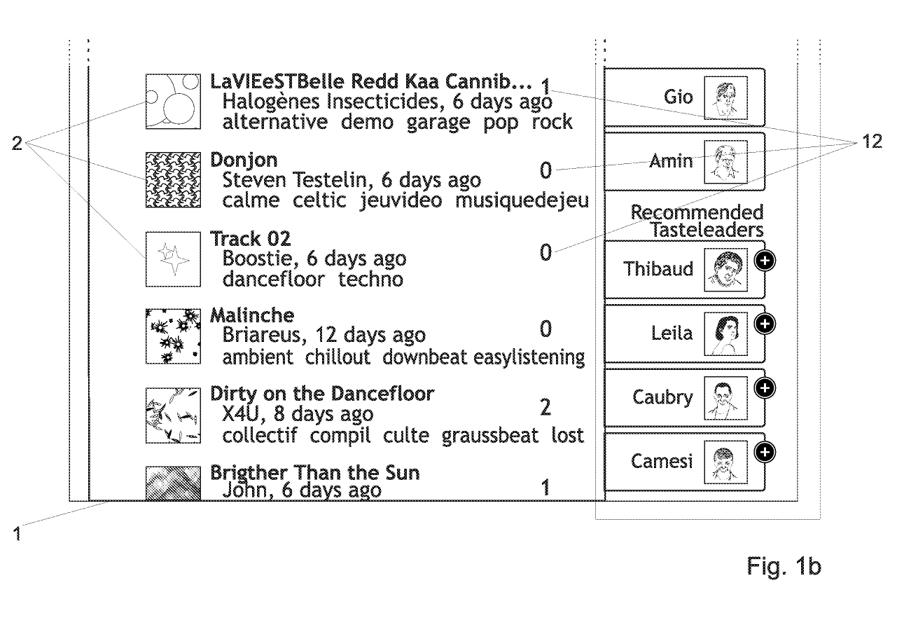

FIG. 1 illustrates, among others, a list 1 of media items 2 presented on a display of the particular user's device. In this example, each media item is presented with a picture, for example an illustration of the album containing a song, a title, an album's title, and metadata including a date of introduction into the system (as will be described) and the category.

The list 1 of media items 2 can also regroup various sets of information that can be passive or initiate an action and that are relevant to the particular media item and/or its consumption by the particular user, such as the number of times it was purchased by all users and whether it was already consumed or not by the particular user. This list can be arranged in a playlist of media items that can be played for example in sequence one after the other from the beginning of the playlist.

The computation of the list 1 may be performed by the user's device and/or by the central server. Various preset filters 6 may be applied to the list; a search box for searching media items corresponding to various criteria and/or different ranking criteria may also be applied to the list.

The particular user may for example filter the list 1 of media items 2 using any criteria relevant to him, such as: genre, mood types, occupation types, geographic regions, language or other cultural attributes and any user's tags associated by them to the content; content attributes including any metadata; content metrics such as date added to the database, number of times played, number of times purchased, number of times recommended, etc.

The area 3 of the display shows information relating to the particular user, including for example a login status, a credit value, a personal score (defined later) and an avatar or photo.

The dedicated view or section 4 on the right side of the screen comprises a list of tabs (or other widgets) associated to other users of the system. Hereafter, this list will be called the Taste Leaders Selectors View. The list is preferably always visible on the screen next to the list of media items.

In the illustrated example, the other user 5 in the list 4 has been selected by the particular user, and the list 1 thus is a source of media items of interest to this other user 5, and thus recommended to the particular user.

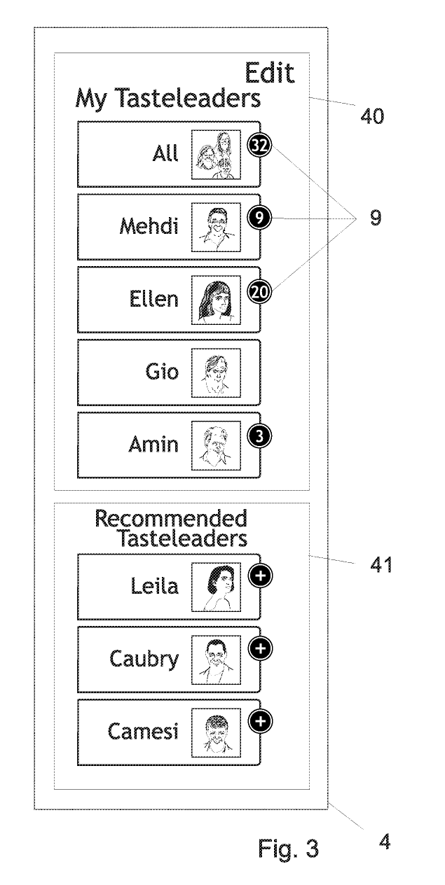

The list 4 of other users may be organized, for example divided in several sections, for example a first section 40 with all the preferred taste leaders of the particular user and a second section with recommended taste leaders 41 for this particular user (FIG. 3). The significance of those two sections will be described later. Generally, the other users in the list 4 correspond for example to members of a community in a social network system (for example a community of people who like free jazz), users manually selected by the particular user (for example family and friends), or users automatically recommended by the system—for example based on previously selected media items.

The media items 2 in the list 1 of the currently selected other user 5 comprises media items of the other user which have been identified as of interest by him/her implicitly and/or for him/her explicitly, personally and on an individual basis, through any form, means or activity in connection with media items performed by this other user, such as for instance:

A. purchasing an item,

B. flagging an item (for later easy access/retrieval and/or to add it to his/her wish list),

C. rating an item,

D. subscribing to an item or to its generating source,

E. loading, playing or executing an item,

F. commenting or blogging an item,

G. Classifying or tagging an item.

The interest of a user for a specific media item may thus be determined by explicit actions (for example recommending an item in a blog) and preferably by implicit actions (purchasing an item, or otherwise using the item). The interest of each user for each media item may be expressed by a numerical value which can depend on some or all the above mentioned actions. This also allows sorting or filtering media items according to their interest for one or several users.

In a preferred embodiment, the recommendations from another user are based on A. (purchase) and/or B. (flagging). Purchasing an item demonstrates an obvious interest of the other user for the selected media item. Flagging still indicates interest but not yet a decision to actually purchase the item.

Rating (C) allows users to rate media items in order to rank them on a personal basis which can be used as an indication of her/his interest for the concerned media item, and thus also be used as a basis for recommendations to other users.

Subscribing (D) is very useful to detect interest from the user(s) in a source, such as a creator or publisher of a media item. This information may be used to later recommend new items generated by this source.

Playing or executing a media item (E) confirms the interest of the user; media items which are often played will be stronger or more often recommended than other media items. Commenting or blogging is also a useful indication, especially if the comment or blog includes scores which can be interpreted by the system.

The list 4 (Taste Leaders Selectors View) comprises a selector for each other user, i.e., a graphical user interface widget that the particular user can click to select and activate another user. Simultaneous selection of several other users from the list is also possible. Furthermore, each selector can point to one other user or to a group of several other users. For example, a selector All allows simultaneous selection of all other users in the list 4. Communities of users (for example a group of friends, a club of heavy metal fans) may be formed by the users themselves, or be automatically defined by the system, and associated with a single selector.

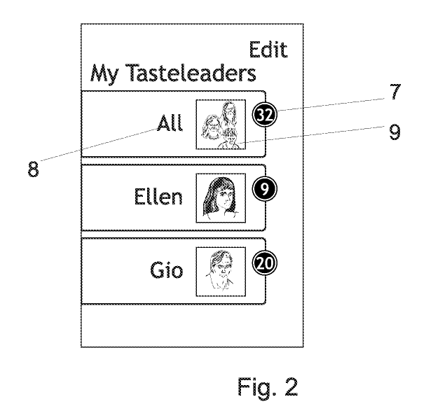

FIG. 2 illustrates three selectors by way of example. As can be seen, each selector comprises a photo or avatar 9 of the other user, the other user's name 8 and a value 7 representing the number of media items unknown or new to the particular user. The particular user can thus immediately see that the other user gio, for example, has 20 new recommendations for media items new to the particular user. This value (counter) corresponds for example to the number of media items of the other user that the particular user never consumed and/or that were unknown to him at the particular time such value was presented to her/him. In this context, consuming means for example watching, reading, listening to, playing or, in the case of software, loading or executing (if embedded in a program) a media item. The value (counter) may be presented within or next to each selector.

The particular user can preferably indicate his preferred other users as sources of media items recommendations. In order to do so, the particular user can regroup and organize his preferred selectors in a dedicated “preferred selectors” (called My Taste Leaders) group or list 40 within the Taste Leaders Selectors View 4. On FIG. 1, the other users mehdi, ellen, gio and amin have been selected by the particular user zeno as preferred source of recommendations, and the selectors corresponding to those users are thus all included in the “MyTasteLeaders” part 40 of the list 4.

The particular user may also organize the other users in various different ways, and for example arrange the order of his preferred selectors as he likes, group selectors, remove selectors or have selectors (or groups of selectors) automatically sorted, filtered, collapsed or expanded. The particular user's preferences are recorded in his personal settings in his device and/or in the central server.

The list 4 preferably also comprises suggestions of new Taste Leaders, i.e., a list of other users that are automatically recommended to him by the system. In order to achieve that, the particular user receives recommendations of other selectors in a dedicated “recommended selectors” section 41 within the Taste Leaders Selectors View 4. On FIGS. 1 and 3, this section 41 is presented right below the preferred selectors group or list 40.

The particular user thus receives recommendations of other users potentially interesting for him as sources of media items recommendations for him. The list of recommended other users in the section 41 may be generated either using a device (for example the central server, or the user's computer) or by means of other users' recommendations to the particular user initiated from other users. For example, the other user ellen trusted by the particular user zeno on FIG. 1 may recommend to zeno one or several other users as taste leaders; those manually recommended other users are added in section 41, possibly with an indication of the origin of the recommendation.

Automatic recommendation of recommended other users in a device may be based for example on a statistical matching between the pools or lists of media items of interest of other users with the pools or lists of media items of interest of the particular user. The device then retrieves other users with similar tastes or having selected similar media items, and recommend the most relevant other users as recommended selectors in section 41 of the particular user.

If a preferred other user selector 5 is selected (as shown in FIG. 1), the list 41 of recommended other users can be the preferred other users of such selected preferred other user. In other words, this provides the particular user with a mean to access the list of preferred other users of one of his preferred other users. In this example, the label “Recommended Tasteleaders” can alternatively be labelled “Ellen's Tasteleaders”.

The list 41 of recommended other users may be filtered for, and/or filtered by, the particular user using any criteria relevant to him and concerning media items of interests to this other user, such as: genre, mood types, occupation types, geographic regions, language or other cultural attributes, etc. A particular user may for example choose to view only recommended other users with matching interests in free jazz.

In a preferred embodiment, automatic recommendation in the list 41 is based at least in part on the level of activity (in connection with media items) they are producing as referrers to other users in the category selected by the particular user. In other words, such recommended other users can be other users having generated, among other users than themselves, the highest number of purchases and/or additions to wish lists, in the category (filtering criteria) currently selected by the particular user.

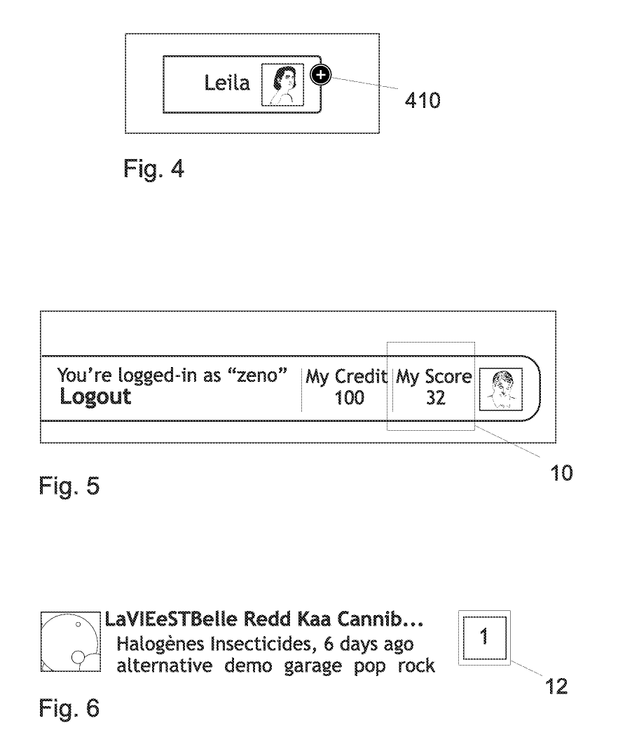

By selecting one or several other users from the list 41, the particular user may thus view lists 1 of media items of interest of those other users. If he likes those media items, the particular user may transfer individually some recommended other users from the list 41 to the list 40 of preferred selector (MyTasteLeaders). This transfer can be performed by the particular user by using a graphical user interface method, for instance by clicking on a dedicated widget button 410 (see FIG. 4) and/or by dragging and dropping a recommended selector to his preferred selectors list.

In another aspect, which can be combined with or used independently of other aspects, the invention also relates to a method for ranking users. The ranking may use a calculated numerical value for each user, wherein this value is a function of the user's activity and/or of the activity of other users in connection with media items.

As can be seen on FIG. 5, a score 10 is thus assigned to each user and possibly displayed next to the user's name or avatar in his personal section 3 of his display, or next to his name or avatar displayed on devices of other users.

The numerical value is calculated for each and every user by the service/application in a computing device, for example by a central server or servers, and/or by the device of the particular user. This score preferably defines the level of activity of each user.

The score assigned to a particular user reflects his level of activity or experience with the system, and may be a function of:
The number of media items purchased by this particular user for herself/himself and for other users.
The number of media items purchased by other users through the particular user's recommendations to them. Those recommendations can be the result of other users having selected a selector pointing to the particular user's media items of interest or any other means of being exposed to the particular user's media items of interest. The recommendations may also be the result of direct, explicit recommendations of media items by the particular user to other users.

The score of each other user may be presented on the computer display of the particular user, and/or used for ranking and/or filtering those other users.

In another aspect, which can be combined with or used independently of other aspects, the invention also relates to another method for ranking users. The ranking in this case uses for each user to rank a calculated numerical value which is a function of the number of times they have been chosen as preferred Taste Leaders, or more generally as a source of media items recommendations, by some or all the other users. A user who is often in section 40 of other users thus gets a high score.

This numerical value thus represents the popularity of each user. Each time User A is chosen by another user to be added in his list 40 of preferred other users, the numerical value associated to User A is increased. This method thus implements a system to rank users by using a score representing in particular their level of influence among other users.

It is also possible to assign negative values to users. User A may for example explicitly or implicitly indicate that he does not trust the recommendations from User B, or he may remove a user from his sections 40 or 41.

Again, this additional numerical value is calculated for each and every user by the service/application in a computing device, for example by a central server or servers, and/or by the device of the particular user. The score may then be presented on a user's display, and/or used for ranking and/or filtering a list of other users. The above mentioned user's score based on activity may be combined with, for example added to, the user's score based on popularity and number of times it was chosen as a preferred other user.

In yet another aspect, which can be combined with or used independently of other aspects, the invention also relates to a method for ranking the media items. In this case, a calculated numerical value is assigned to each or at least to some media items as a function of the number of times each media item has been (explicitly and/or implicitly) identified as being of interest for all users. In a preferred embodiment, the score assigned to each media item depends at least, but possibly not only, on the number of times it has been purchased and/or flagged by other users or by other preferred users. Other means to show his interest for a media item and to increase or reduce its score may include rating, subscribing, loading, playing, executing, commenting or blogging the item, as above described. The increment step may depend on the flag or note assigned to the media item by the user.

In an embodiment, flagging a media item is only temporary incrementing its score, for example for one week or one month, after which such increment is cancelled. Other methods to decay the score, for example an increment that exponentially decreases with time, may be used. On the other side, purchasing a media item causes a permanent, or more slowly decreasing, change of the media item score. The invention thus also relates to a method for scoring a media item, wherein the score is increased when users identify this media item as of interest, wherein the score is automatically decreased as a function of time, and wherein the decrease function or rate depends on the type of action with which the user showed his interest for the media item. The goal here is to have a mechanism where flagging is only temporary contributing to build the popularity of the media item, but only purchasing can seal its fame and score value.

Again, this score may be computed for each and every media item by the service/application in a computing device, for example by a central server or servers. The score may then be presented on a user's display, as shown with reference 12 on FIG. 6, and/or used for ranking and/or filtering a list of media items.

The score assigned to each media time may depend on time; a media item which has recently been consumed often by the users will get a better score than another media item consumed the same number of times but less recently. The method thus privileges new media items over media items that are older or have meanwhile gone out of fashion. For this, the score assigned to each media item may for example depend only on the number of uses of this media item within a time frame that the particular user can set. This allows a user to discover media items that have appeared during the last 24 hours, or during the last month, or during the last year.

The score is for example a function of the interest (as defined above) of all the users of the service/application for the particular media item. It is also possible to define a score which only depends on consumption by trusted or selected other users—for example in order to retrieve the latest popular media items among lovers of hip hop, or among a specific community.

This score may be presented on the user's display, for example next to each media item, and used for ranking and/or for filtering a list of media items. In one aspect, the method thus allows a particular user to filter a list of media items presented to him by means of a numerical value in order to select media items with a score either above and/or equal to, or below and/or equal to, or equal to a threshold. This method allows the particular user to easily filter out media items that do not have a desired score or that have scores below or above a certain value.

Optionally, this filter may be combined with any of the above mentioned filters.

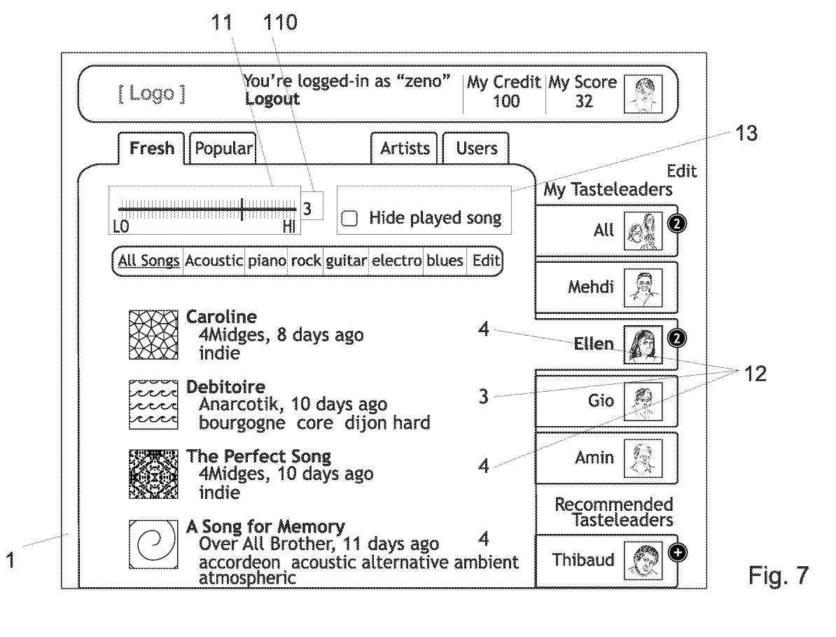

In one embodiment, a graphical user interface widget, for example on a device display, is used for setting the threshold. An example of widget using a linear slider 11 is shown on FIG. 7. Other widgets, including for example rotary sliders or buttons, may also be used. The widget preferably allows the particular user to select a suitable threshold with an acceptable range of values; this range of values has both a minimal and a maximal value which can respectively be the lowest media item score value and the highest media item score value available in the pools or lists of media items to be presented to the particular user at a particular time and in a particular context.

The selection of a specific threshold with the widget 11 has for effect to filter the list 1 and to display only media items having scores that are either but preferably above and/or equal to, or below and/or equal to, or equal to the threshold. In the example of FIG. 7, the linear slider is on value “3” (reference 110) and only media items with a score greater than or equal to this threshold are displayed in the list 1; other, presumably less important media items, are discarded. This allows a user to rapidly select in a list only the media items which are really important, i.e., those media items with a high score which are often consumed (within a specific time frame) by all other users or by trusted users.

The resulting media items presented are preferably presented and sorted in order of newest media items first (inverse chronological order). The date is preferably the date of storage in the system, or another date stored as part of the metadata associated with the media item. The newest media item may thus be the media item with the most recent date at which this item was posted on the service/application or made available to all users. Alternatively, the newest media item may be the item with the most recent date at which it was identified as being of interest by the user(s).

In one aspect, the method also relates to a method for filtering a list of media items presented to a particular user by means of selecting only those that have never been played by the particular user.

This method allows the particular user to easily filter out media items that he has already consumed (as above described) in order to expose him only to media items that are new to him. Optionally, this filter may be combined with any of the above mentioned filters.

The selection of unplayed media items is preferably made with a graphical user interface widget, for example a two states button or a check box such as the button 13 shown on FIG. 7. The two states trigger the display of either all media items of a current context or only the media items of a current context that have never been consumed by the particular user.

In an embodiment, the already known media items are not removed, but marked differently (for example greyed) or presented on a different section of the display.

In another aspect, the invention also relates to a method for presenting media items to a particular user in several, for example two, complementary sections or views. According to this aspect, a plurality of complementary display views (or sections) are used, each view presenting media items in its own specific way. A first view 15 allows for example the particular user to access easily the newest (freshest) media items which encourage and facilitate the discovery of new items. A second view 16 allows the particular user to easily access the media items having the highest score, which encourages and facilitates access to higher quality media items having been elected as popular by all users. Additional views may be used.

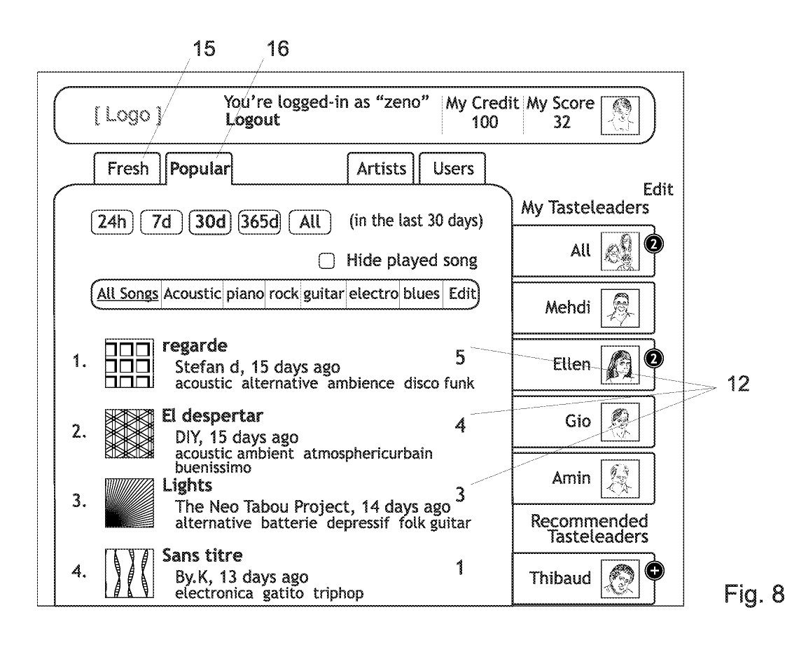

In the example of FIG. 8, a first view 15, called “Fresh”, displays media items sorted in order of newest media items first (inverse chronological order, as in FIG. 7). A second view 16, called “Popular”, displays media items sorted in order of most popular media items first. Most popular in this context means having the highest media item score. Both views are advantageously located next to each other, using for example overlapping frames or tabs, for immediate access by the user. Their totally different and complementary natures are thus emphasized.

In another aspect, the invention also relates to a method for tracing, storing and making use of all steps of the propagation of a media item of interest in a chain of its consecutive referrers.

This method allows the history (all steps of the propagation) of the consecutive exposures of a media item of interest in a chain of its consecutive referrers (recommending users) to be traced and stored. The particular user can thus examine the chain of interest for a media item exposed to him, potentially through several other users in between, in order, for instance, to discover new interesting other users. This allows the particular user to access/examine the “word-of-mouth” origin of any media item presented to him.

The history of a media item that can be retrieved thus comprises a list of referrers, with dates of transfer from one referrer to the next and the place, i.e. location, page or section of the service/application where the media item was initially discovered (such as the Fresh view, Popular View) or later referred. A referrer is another user having media items of interest to him that a next referrer or the final particular user is being exposed to.

Each user exposed to a media item recommended by a referrer can in turn become a referrer for other users if this media item presented to him becomes of interest to him (for example if he buys, plays, executes, recommends, etc. the media item, as described above). The chain of consecutive referrers is thus a chronologically ordered list of all users, from the first one in the chain who initially showed interest for one particular media item, to the last one who was exposed to this particular media item and was interested in it. This chain may also indicate the nature of interest each one of them had in the media item (for example if he bought the media item, made an explicit recommendation, etc).

There can be several such chains of consecutive referrers for each media item, as each media item can initially become of interest for several users independently, thus creating several chains of consecutive referrers for one media item.

A particular user can thus be presented with, and/or access, all the chains of consecutive referrers in order to get information on all the referrers for all media items he is being exposed to and get information on the nature of the interest all these referrers had in a particular media item.

According to an aspect of the invention, the user's interest (explicit or implicit, as described above) is communicated to other users. This may violate the user's privacy or at least be considered undesirable by some users. This problem is however limited, because the users may decide to communicate only an alias 8 to other users, for example an alias where an identification of the user is not possible. In addition, users may decide within the invention to restrict the rights of other users to access their interests. A user may for example decide to let only known users, for example within a closed user group or a shared community, access his interests or profile.

The different aspects of the invention can be used and is claimed separately from each other. Any combination between any two or more of the aspects can also be used and is claimed.

The method of the invention thus allows an automatic, computer-based generation of lists of media items that a particular user may want to see or otherwise consume. This list may be short but contains media items which are very likely to interest the particular users. The transmission, display and storage of this list are thus considerably faster than the transmission, display and storage of a list comprising all the media items a user can theoretically access. The invention thus also relates to the compression of the size of lists of media items, using an automatic step of retrieving only media items likely to interest a particular user, and discarding other less interesting media items.

The various lists displayed to a particular user may be generated by one or several central web servers which generate dynamic web pages according to the settings, preferences, history and list of preferred taste leaders of this particular user. The web server in this case combines information stored in a database and concerning several users in order to generate well-adapted web pages with playlists that match the interest of the particular user, and which can be transmitted and displayed very fast and effectively.

The invention also relates to a computer program product, including optical and/or magnetic memories, that stores a program which can be executed by a device, for example a central server and/or a user's device, in order to carry out the any of the above described methods or aspects of the invention.

1. A method for recommending media items to a particular user,
where a list of other users is presented on a user device display to said particular user, and
where a set of media items has been identified as being of interest by and/or for said other users in said list, personally and on an individual basis, and
where a list of media items identified as being of interest by one or several selected other users in said list is automatically generated and presented on said user's device display.

2. Method according to claim 1, wherein said list of other users is presented on said user device display simultaneously with said list of media items.

3. Method according to claim 2, wherein said list of media items is a playlist of media items,
wherein a media item in a playlist can be played by selecting this media item in said playlist.

4. Method according to claim 1, comprising a step of presenting a consolidated list of media items recommended by all or by a subset of several other users.

5. Method according to claim 1, wherein said list of other users is divided in at least two sub-sections,
wherein a first sub-section comprises a particular user's list of preferred other users,
wherein a second sub-section comprises a list of other users recommended to said particular user.

6. Method according to claim 5, wherein other users are automatically recommended to said particular user based on matching of interests.

7. Method according to claim 5, comprising a step performed by the particular user of adding manually one or several recommended other users in said list of his preferred other users.

8. Method according to claim 1, wherein a user implicitly identifies a media item as being of interest to him, for example by purchasing, flagging, adding to a wish list, subscribing to a source, playing, loading, executing, commenting, blogging, classifying, tagging, storing and/or using this media item.

9. Method according to claim 1, wherein each other user in said list is associated with a value representing the number of unknown or new media items that the particular user has never consumed and/or that were unknown to him.

10. Method according to claim 1, comprising a step of filtering said list of media items using one or several criteria relevant to said particular user, including at least one among: genre, mood types, geographic regions, language or other cultural attributes and user's tags associated to the content; content attributes including any metadata; content metrics such as date added to the database, number of times played, number of times purchased, number of times recommended.

11. Method according to claim 1, comprising a step of filtering said list of other users using one or several criteria including at least one among: genre, mood types, geographic regions, language or other cultural attributes, number of times recommended.

12. Method according to claim 1, comprising a step of ranking users, using for each one of them a calculated numerical value which is a function of their activity in connection with media items.

13. Method according to claim 1, comprising a step of ranking users, based on the activity said users are generating on media items when said users are used as referrers by other users.

14. Method according to claim 1, wherein said activity comprises flagging to add to a wish list or purchasing the media item.

15. Method according to claim 1, wherein other users are automatically recommended to said particular user based on said ranking of other users.

16. Method according to claim 1, comprising a step of ranking users, using for each one of them a calculated numerical value which is a function of the number of times they have been included by some or all users in their list of preferred other users.

17. Method according to claim 1, comprising a step of ranking media items, using for each one of them a calculated numerical value that is a function of the number of times each media item has been identified as being of interest by some or all users.

18. Method according to claim 17, wherein said numerical value (12) assigned to the media item decreases with time.

19. Method according to claim 18, wherein the rate or function of decrease depends on the action with which a user showed his interest for the media item.

20. Method according to claim 16, comprising a step of filtering said list of media items by presenting only media items having a numerical value either above and/or equal to, or below and/or equal to, or equal to a threshold.

21. Method according to claim 1, comprising a step of filtering said list of media items by presenting only those that have never been played by the particular user.

22. Method according to claim 16, comprising a step of presenting media items to said particular user in two complementary views,
wherein a first view allows the particular user to easily access the newest media items and a second view allows the particular user to easily access the media items having the highest numerical value.

23. Method according to claim 20, comprising a step of manipulating a widget for defining said threshold value,
wherein media items whose numerical value has a specific relation to said threshold are filtered out of said list of media items.

24. Method according to claim 1, comprising a step for the particular user to access, for at least one media item presented to him, a chain of consecutive referrers.

25. The method of claim 24, wherein said chain indicates the nature of the interest each referrer had in the media item and/or the place from where it was referred.

26. A method comprising the steps of:
presenting on a user's display a list of other users having at least two sub-sections, one first sub-section comprising said user's list of preferred other users, a second sub-section comprising a list of other users automatically recommended to said user based on matching of interests;
simultaneously presenting on another portion of said display a playlist of media items, said playlist being personal and individual for said user, wherein a media item in said playlist can be played by selecting this media item;
wherein media items identified as being of interest by one or several selected other users in said list of other users are identified and used for generating said playlist of media items.

27. Method according to claim 26, further comprising the following steps performed by said user:
adding manually one or several automatically recommended other users in said list of his preferred other users,
initiating a filtering of said list of other users using one or several criteria including at least one among: genre, mood types, geographic regions, language or other cultural attributes, number of times recommended, wherein said filtering modifies the content of said playlist.

28. Computer program product that stores a program which can be executed by a device in order to carry out the method of claim 26.
